(19) United States
(12) Patent Application Publication
(10) Pub. No.: US 2018/0009130 A1
(43) Pub. Date: Jan. 11, 2018

(54) SEPARATING DEVICE FOR THE CHIP-FREE CUTTING OF WAFERS OF DONOR SUBSTRATES

(71) Applicant: SILTECTRA GmbH, Dresden (DE)

(72) Inventor: Jan Richter, Dresden (DE)

(73) Assignee: SILTECTRA GmbH, Dresden (DE)

(21) Appl. No.: 15/543,897

(22) PCT Filed: Jan. 13, 2016
(86) PCT No.: PCT/EP2016/050576

§ 371 Date: Jul. 14, 2017

(30) Foreign Application Priority Data
Jan. 15, 2015 (DE) 10 2015 000 450.6

(51) Int. Cl. B28D 5/00

(52) U.S. Cl. CPC B28D 5/0047

(57) ABSTRACT

The present invention relates to a device (1) for separating at least one wafer from a donor substrate (2). The device (1) according to the invention comprises at least a housing (4) with a receiving space (6) for receiving at least one multi-layer arrangement (8) which consists of at least one donor substrate (2) and a receiving layer (10) arranged or generated thereon, and an application device (12) for the contactless application of the multi-layer arrangement (8) for generating crack-conducting stresses in the multi-layer arrangement (8).

According to claim 1, the present invention relates to a device for chip-free cutting of at least one wafer from a donor substrate.

Materials such as silicon, germanium or sapphire, often in the form of thin slices and panels (called wafers) are used in many technical fields (e.g., microelectronics or photovoltaic technology). At the moment, such wafers are typically produced by sawing from an ingot, wherein relatively large material losses (“kerf-loss”) occur. Since the starting material used is often very expensive, considerable efforts are being made to consume less material in the production of such wafers, thereby rendering it more efficient and less expensive.

For example, with the methods usually employed for producing silicon wafers for solar cells at the moment, almost 50% of the material used is wasted as “kerf-loss”. Globally, this is equivalent to an annual loss of over 2 billion euros. Since the costs of the wafer constitute the largest portion of the costs of the finished solar cell (over 40%), corresponding improvements in wafer production might reduce the costs of solar cells significantly.

Methods which do not rely on conventional sawing and are able to separate thin wafers from a thicker workpiece directly by using e.g. thermally induced stresses appear particularly attractive for such wafer production without kerf loss (“kerf-free wafering”). These include in particular methods as described in PCT/US2008/012140 and PCT/EP2009/067539 for example, in which a polymer layer applied to the workpiece is used to generate such stresses.

The objects of the abovementioned proprietary protection documents are incorporated in the object of the present protection document in their entirety by this reference thereto.

In the methods cited, the coefficient of thermal expansion of the polymer layer is approximately two orders of magnitude greater than than of the workpiece. Moreover, a glass transition may be used to achieve a relatively high modulus of elasticity in the polymer layer, thereby inducing stresses in the polymer layer-workpiece layer system by cooling that are large enough to enable the wafer to be split from the workpiece.

It is the object of the present invention to provide a device for chip-free separation of at least one solid portion from a donor substrate.

The abovementioned object is solved according to claim 1 with a device for chip-free cutting of at least one wafer of a donor substrate or with a separating device. The device according to the invention comprises at least one housing with a receiving space for receiving at least one multi-layer arrangement consisting of at least one donor substrate and a receiving layer arranged or generated thereon, and an application device for the contactless application of the multi-layer arrangement for generating crack conducting stresses in the multi-layer arrangement. The receiving layer preferably consists of a polymer, in particular polydimethylsiloxane (PDMS).

This solution is advantageous because for the first time it provides a device for a chip-free method for separating wafers from a donor substrate, particularly from a thick wafer or an ingot, wherein the device is inexpensive to produce, may be used repeatedly and requires little installation space.

Further advantageous variants are discussed in the following description and/or the subordinate claims.

According to a preferred variant of the present invention, the crack initiating stresses may be generated contactlessly by the application device. This variant is advantageous because the initiation and conducting of cracks can be controlled and/or induced by a single device, so no other device is needed, and a very small, compact, energy-conserving construction may be realised.

According to a further preferred variant, a crack initiating device for initiating the crack is provided, wherein a crack may be initiated by means of the crack initiating device either contactlessly or by contact with the multi-layer arrangement, particularly with the solid body. This variant is advantageous because a crack may be caused in a controlled manner by means of the crack initiating device. The crack initiating device may also initiate the crack by means of an effect which differs from the effect generated by the application device for conducting cracks. The crack initiating device is preferably a spray nozzle, in particular for controlled feeding of the fluid substance to the multi-layer arrangement, particularly the donor substrate, or a sound generation device or a radiation device, in particular a laser, or a pressure generating device, which causes the crack initiation locally, e.g., by physical contact with the multi-layer arrangement, in particular with the solid body.

According to a further preferred variant, the application device is designed to introduce a fluid substance into the receiving space. Preferably, the temperature of at least portions of the multi-layer arrangement, in particular the receiving layer, may be controlled by means of the fluid substance in such manner that the crack initiating stresses and/or the crack conducting stresses are generated in the solid body by the receiving layer. The receiving layer preferably has a coefficient of thermal expansion auf that differs from the coefficient of thermal expansion of the donor substrate by at least one order of magnitude, wherein stresses are generated in the solid body by thermal shocking of the receiving layer in such manner that a crack spreads along a separating area in the solid body due to the stresses, by which the portion of the solid body is separated from the solid body.

This variant is advantageous because the fluid substance may be stored and/or prepared outside of the housing, particularly in a storage receptacle, particularly a tank. Preferably, multiple devices according to the invention may be coupled to the storage receptacle, wherein all coupled devices are preferably supplied with the fluid substance from the same storage receptacle. The device according to the invention particularly preferably includes a coupling with the storage receptacle via a line connection.

According to a further preferred variant of the present invention, the application device includes a feed means and preferably multiple feed means for feeding the fluid substance into the receiving space, particularly to the multi-layer arrangement disposed inside the receiving space. At least of the feed means is preferably designed or operable in such manner that a crack formation may be caused with said feed means, wherein the fluid substance may be sprayed into the receiving space in the form of a mist through at least one of the feed means. The receiving layer preferably has a coefficient of thermal expansion which differs from the coefficient of thermal expansion of the donor substrate by at least an order of magnitude, wherein the thermal shocking applied to the receiving layer leads to the generation of stresses in the solid body in such manner that a crack is initiated in the solid body by the stresses, by which the solid body portion is separated from the solid body.

The feed means preferably include misting elements. In addition, a pump device is preferably provided for transporting the fluid substance from the storage receptacle to the one or more feed means.

Die fluid substance is preferably a fluid and particularly preferably a gas or a liquid, particularly liquid and/or gaseous nitrogen (N₂). The fluid Substanz particularly preferably has a nebulous or mist-like form. This is advantageous because the fluid substance may be selected in such manner that the temperature of the multi-layer arrangement may be controlled in a defined way therewith. The use of liquid nitrogen as the fluid substance enables rapid cooling, since liquid nitrogen has a temperature lower than −196° C., but nebulous or mist-like nitrogen, preferably with a temperature higher than −196° C. is preferred.

According to a further preferred variant of the present invention, the receiving space may be evacuated, wherein a vacuum pump is preferably provided that forms an operative connection with the receiving space. This variant is advantageous because all unwanted substances, particularly water, may be removed from the receiving space simply and effectively by evacuation. With this variant, it is possible to prevent or reduce the collection of water on the multiple arrangement and/or the interior space and/or the separated solid body portion, for example.

According to a further preferred variant of the present invention, a holding and/or homogenising device is arranged in the receiving space for holding and/or homogenising the fluid substance that is introduced into the receiving space, the holding and/or homogenising device preferably being tubular, in particular annular. This variant is advantageous because the holding and/or homogenising device is able to convert the fluid substance introduced into the receiving space into a configuration in which it acts on and controls the temperature of the multi-layer arrangement advantageously, in particular uniformly.

According to a further preferred variant of the present invention, a heating system is arranged in the receiving space or on the housing for controlling the temperature of the donor substrate and/or the receiving space, the heating system is able to heat the donor substrate and/or the receiving space preferably from a temperature below 0° C., particularly below −50° C. or below −100° C. or below −150° C. to room temperature. This variant is advantageous because it prevents liquid from condensing on the solid body and/or in the receiving space, for example. Moreover, this variant serves to prevent thermal shocks that may occur if the donor substrate is warmed up too quickly (e.g., due to opening of the housing).

According to a further preferred variant of the present invention, a spring-mounted or damped catching device is arranged in the receiving space for springy or low-impact receiving of the separated wafer, wherein the spring-mounted or damped catching device is preferably arranged on the holding and/or homogenising device. This variant is advantageous because the separated wafer or solid body portion tends to spring away, particularly in the longitudinal direction of the donor substrate in response to the forces introduced into the solid body or the donor substrate during the separation. The wafer or solid body portion may be held or restrained in controlled manner with this variant, thereby preventing the wafer or solid body portion and/or the receiving spaces and/or devices inside the receiving space from being damaged.

The solid body or the workpiece or donor substrate preferably contains a material or combination of materials from one of main groups 3, 4 and 5 of the Periodic Table of the Elements, such as Si, SiC, SiGe, Ge, GaAs, InP, GaN, Al2O3 (sapphire), AIN. The solid body particularly preferably includes a combination of the elements occurring in the third and fifth groups of the Periodic Table. Conceivable materials or material combinations are e.g., gallium arsenide, silicon, silicon carbide, etc. The solid body may also contain ceramic (e.g., Al2O3—aluminium oxide) or consist thereof, in this context preferred ceramics are e.g., perovskite ceramics (e.g., ceramics containing Pb, O, Ti/Zr) in general, and lead-magnesium-niobate, barium titanate, lithium titanate, yttrium-aluminium-garnet, particularly yttrium-aluminium-garnet crystals for solid body laser applications, surface acoustic wave (SAW) ceramics such as lithium niobate, gallium orthophosphate, quartz, calcium titanate, etc. in particular. The solid body thus preferably contains a ein semiconductor material or a ceramic material, and/or the solid body particularly preferably consists of at least one semiconductor material or a ceramic material. It is further conceEs ist weiterhin conceivable that the solid body may include a transparent material or consists in part or is manufactured from a transparent material such as sapphire. Further materials which may be considers as solid body either alone or in combination with another material are for example “wide band gap” materials, InAISb, high temperature superconductors, in particular rare earth cuprates (e.g., YBa2Cu307). It is also conceivable additionally or alternatively that the solid body is a photomask, wherein in the present case preferably any photomask material known on the filing date and and particularly preferably combinations thereof may be used as the photomask material.

In preferably all cases in which the word is used in the context of the present invention, use of the word “substantially” defines a deviation in the range of 1%-30%, particularly 1%-20%, more particularly 1%-10%, more particularly 1%-5%, more particularly 1%-2% from the definition that would be expressed without the use of this word.

Other advantages, objectives and properties of the present invention will be explained with reference to the following of the accompanying drawing, in which an exemplary version of the device according to the invention is represented. Components or elements of the device according to the invention which at least substantially correspond to each other in terms of function may be identified in the figures by the same reference signs, although said components are not necessarily all labelled or explained in all figures.

In the drawing:

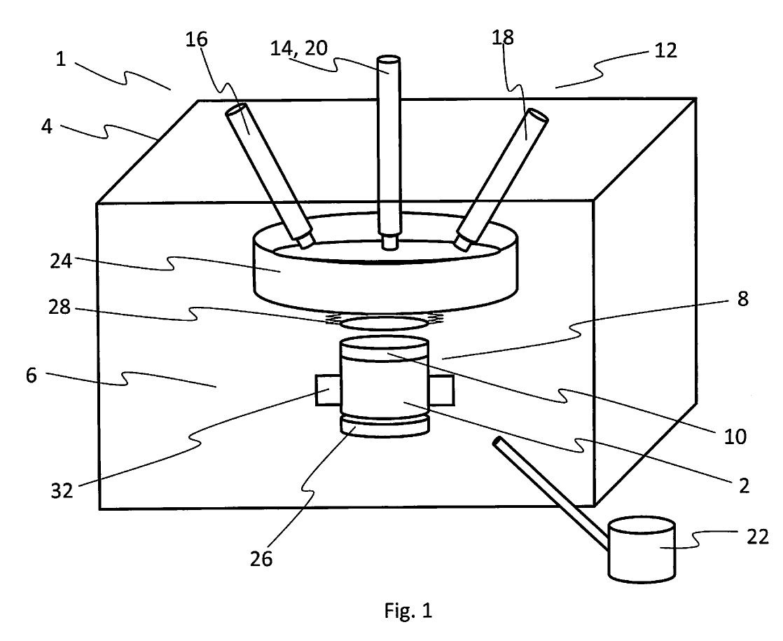

FIG. 1 is a schematic representation of the devices that cooperate inside the receiving space of the device according to the invention; and

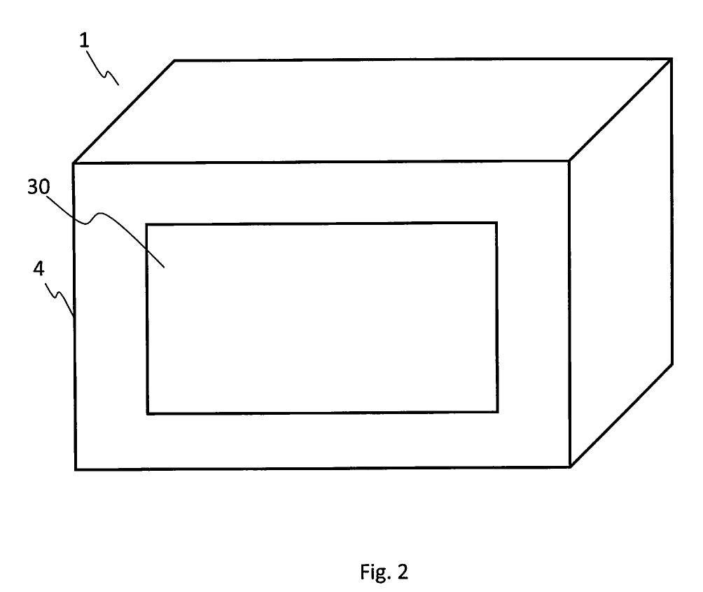

FIG. 2 is a schematic view from the outside of the separating device according to the invention.

FIG. 1 shows device 1 according to the invention for cutting at least one solid body portion, in particular a wafer, e.g., an 8-inch wafer, from a donor substrate 2. It is evident from the representation that the separating device according to the invention preferably includes at least a housing 4 with a receiving space 6 for receiving at least one multi-layer arrangement 8, wherein multi-layer arrangement 8 preferably has a donor substrate 2 and a receiving layer 10 arranged or generated thereon, and an application device 12 for the contactless loading of multi-layer arrangement 8 to generate at least crack conducting stresses in multi-layer arrangement 8.

Reference sign 14 preferably identifies a crack initiating device for starting the crack, wherein crack initiation by means of crack initiating device 14 may preferably be effects without contact or by contact with multi-layer arrangement 8, particularly donor substrate 2. In the case shown, the crack initiating device is preferably designed as a special feed means 20 for feeding the fluid substance, particularly liquid nitrogen.

Application device 12, which preferably comprises feed means 16, 18, 20, preferably serves to introduce the fluid substance into receiving space 6. The temperature of at least a portion of multi-layer arrangement 8, particularly of receiving layer 10, is controllable, particularly coolable, by means of the fluid substance, to such effect that the crack initiating stresses and/or the crack conducting stresses are generated by compression of receiving layer 10 in donor substrate 2. Feed means 16, 18, 20 or one of the feed means or at least one of the feed means is preferably designed as a spray nozzle or includes the spray nozzle. The one or more other feeds are then preferably designed to atomise the fluid substance, particularly the liquid nitrogen.

Housing 4 is preferably closable in such manner that receiving space 6 may be evacuated. Preferably a pump device, particularly a vacuum pump 22, is provided, which forms an operative connection with receiving space 6 such that the freely movable substances, particularly impurities such as gases or liquids or dust, can be ejected from receiving space 6 via the operative connection.

Reference sign 24 denotes a holding and/or homogenising device for holding and/or homogenising the fluid substance which is introduced into receiving space 6, which device is preferably arranged in receiving space 6. Holding and/or homogenising device 24 is preferably tubular, particularly annular or ring-shaped.

In addition, a heating device 26 is preferably arranged in receiving space 6 or on housing 4 to control the temperature of the donor substrate 2.

Reference sign 28 refers to a spring-mounted or damped catching device, which is arranged preferably above the donor substrate, in the longitudinal direction of the donor substrate in receiving space 6, preferably for springy or low-impact receiving of the separated wafer.

Multi-layer arrangement 8 is preferably aligned and/or fixed with the aid of a positioning and/or fixing device 32. The positioning and/or fixing device preferably cooperates in friction-locking and positive-locking manner with multi-layer arrangement 8.

FIG. 2 shows another schematic view of housing 4 of separating device 1. This view shows the presence of an opening and closing device 30, which is designed to introduce the multi-layer arrangement 8 into receiving space 6 or to take the separated solid body portion and the reduced donor substrate 2 out of receiving space 6. Opening and closing device 30 is preferably closable in such manner that a partial vacuum or a vacuum or substantially vacuum-like conditions with respect to the ambient pressure may be created in the interior of housing 4, in particular in receiving space 6.

Housing 4 of device 1 according to the invention particularly preferably extends less than 100 cm, more particularly less than 60 cm or less than 50 cm in the lateral direction. Housing 4 preferably extends up to 30 cm or exactly 30 cm or up to 35 cm or up to 40 cm in the lateral direction. Housing 4 of device 1 according to the invention particularly preferably extends less than 100 cm, more particularly less than 60 cm or less than 50 cm in the lengthwise direction. Housing 4 preferably extends up to 30 cm or exactly 30 cm or up to 35 cm or up to 40 cm in the lengthwise direction. Housing 4 of device 1 according to the invention particularly preferably extends less than 100 cm, more particularly less than 60 cm or less than 50 cm in the upward direction. Housing 4 preferably extends up to 30 cm or exactly 30 cm or up to 35 cm or up to 40 cm in the upward direction. Because of the small dimensions of the housing, it is not difficult to perform multiple separation processes of solid body portions simultaneously by placing a relatively large number of devices according to the invention in a small space.

For cutting the solid body portion, the following steps are preferably carried out: preferably in a first step, multi-layer arrangement 8 is introduced into receiving space 6. Then, a vacuum is preferably created. In a further step, the fluid material, particularly liquid nitrogen is introduced, particularly sprayed, into receiving space 6, preferably from above. In this way, the temperature of receiving layer 6 and/or of donor substrate 2 may be controlled, particularly cooled, extremely precisely. Receiving layer 6 is preferably cooled by the fluid material to a temperature below the glass transition temperature of the material of receiving layer 6. Particularly preferably, a small part of multi-layer arrangement 8, in particular of donor substrate 2 and/or receiving layer 6 is cooled in a closely defined manner via a feed means 20 preferably in the form of a split nozzle. In this context, a small part is understood to be an area preferably smaller than one third or smaller than one sixth or smaller than one tenth of smaller than one twentieth of smaller than one thirtieth of the surface area of receiving layer 6. In a further step a movement of the separated solid body portion or wafer is preferably cushioned or damped by a catching device 28 or spring-mounted and/or damping device, so that the separated, particularly split solid body portion comes to rest on the donor substrate 2 or workpiece. After the solid body has been cut, the donor substrate is preferably heated to a temperature above 0° C., preferably above 10° C. and particularly preferably to room temperature, by means of a heating device 26, particularly an electric resistance heater. In a last step, housing 4 is opened and the separated solid body portion is removed from receiving space 6. It is further conceivable for the donor substrate 2 to be replaced as well, or for the donor substrate to be coated with a fresh receiving layer.

### LIST OF REFERENCE SIGNS

1 Device
2 Donor substrate
4 Housing
6 Receiving space
8 Multi-layer arrangement
10 Receiving layer
12 Application device
14 Crack initiation device
16 First feed means
18 Second feed means
20 Third feed means
22 Pump device
24 Holding and/or homogenising device
26 Heating device
28 Catching device
30 Opening and closing device
32 Positioning and/or fixing device

1. Device (1) for cutting of at least one solid body portion, in particular a wafer, from a donor substrate (2), in particular an ingot,
at least comprising
a housing (4) with a receiving space (6) for receiving at least one multi-layer arrangement (8), consisting of at least one donor substrate (2) and one receiving layer (10) arranged or generated thereon, and
an application device (12) for the contactless application of the multi-layer arrangement (8) for generating crack conducting stresses in the multi-layer arrangement (8).

2. Device according to claim 1,
characterised in that
crack initiating stresses are also generated without contact by the application device (12).

3. Device according to claim 1,
characterised in that
a crack initiating device (14) is provided to initiate the crack,
wherein a crack initiation can be effected by the crack initiating device (14) either contactlessly or by contact with the multi-layer arrangement (8), in particular the donor substrate (2).

4. Device according to any one of the preceding claims,
characterised in that
the application device (12) is designed to introduce a fluid substance into the receiving space (6), wherein the temperature of at least a part of the multi-layer arrangement (8), particularly the receiving layer (10), can be controlled by means of the fluid substance in such manner that the crack initiating stresses and/or the crack conducting stresses are generated in the donor substrate (2) via the receiving layer (10),
wherein the receiving layer has a coefficient of thermal expansion that differs from the coefficient of thermal expansion of the donor substrate (2) by at least an order of magnitude,
wherein stresses are created in the solid body (2) by the thermal shocking of the receiving layer (10) in such manner that the stresses lead to a crack in the solid body (2) along a separation area, by which the solid body portion is separated from the solid body (2).

5. Device according to any one of the preceding claims,
characterised in that
the application device (12) includes a plurality of feed means (16, 18, 20) for feeding the fluid substance, in particular liquid nitrogen, wherein the fluid substance can be sprayed into the receiving space (6) in the form of a mist through at least one of the feed means (16, 18, 20), wherein preferably at least one of the feed means (20) is configured or operable in such manner that a crack initiation can be caused be means of said feed means (20),
wherein die receiving layer has a coefficient of thermal expansion that differs from the coefficient of thermal expansion of the donor substrate (2) by at least one order of magnitude,
wherein stresses are created in the solid body (2) by the thermal shock from the receiving layer (10) in such manner that the stresses initiate a crack in the solid body (2), by which the solid body portion is separated from the solid body (2).

6. Device according to any one of the preceding claims,
characterised in that
the receiving space (6) is designed such that it can be evacuated, wherein preferably a pump device, particularly a vacuum pump (22) is provided, which forms an operative connection with the receiving space (6).

7. Device according to any one of the preceding claims,
characterised in that
a holding and/or homogenising device (24) is arranged in the receiving space (6) for holding and/or homogenising the fluid substance which is introduced into the receiving space (6), wherein the holding and/or homogenising device (24) is preferably tubular, particularly annular in shape.

8. Device according to any one of the preceding claims,
characterised in that
a heating device (26) for controlling the temperature of the donor substrate (2) is arranged in the receiving space (6) or on the housing (4), wherein heating of the donor substrate (2) preferably from a temperature below 0° C., in particular below −50° C. or below −100° C. or below −150° C., to room temperature can be effected by the heating device (26).

9. Device according to any one of the preceding claims,
characterised in that
a spring-mounted or damped catching device (28) is arranged in the receiving space (6) for springy or damped catching of the separated solid body portion, wherein the spring-mounted or damped catching device (28) is preferably arranged on the holding and/or homogenising device (24).
